(19) United States
(12) Patent Application Publication
(10) Pub. No.: US 2015/0244001 A1
(43) Pub. Date: Aug. 27, 2015

(54) METHOD AND AN ELECTRODE PRODUCED BY INFILTRATION

(71) Applicant: DANMARKS TEKNISKE UNIVERSITET, Lyngby (DK)

(72) Inventors: Alfred Junio Samson, Paranaque City (PH); Martin Søgaard, Ringe (DK); Nikolaos Bonanos, Roskilde (DK); Christodoulos Chatzichristodoulou, Copenhagen N (DK); Peter Vang Hendriksen, Hillerod (DK)

(21) Appl. No.: 14/430,815

(22) PCT Filed: Oct. 10, 2013
(86) PCT No.: PCT/DK2013/050319

§ 371 Date: Mar. 24, 2015

(30) Foreign Application Priority Data
Oct. 19, 2012 (EP) 12189207.9

(51) Int. Cl. H01M 4/90; H01M 4/88

(52) U.S. Cl. CPC H01M 4/9041; H01M 4/8846; H01M 4/8882; H01M 4/9033; H01M 2008/1293

(57) ABSTRACT

The present invention relates to electrodes having Gd and Pr-doped cerium oxide (CGPO) backbones infiltrated with Sr-doped LaCoO₃ (LSC) and a method to manufacture them. Pr ions have been introduced into a prefabricated CGO backbone by infiltrating Pr nitrate solution followed by high temperature firing. The high temperature firing allows the Pr ions to diffuse into the CGO backbone. The resulting backbone would then have a co-doped subsurface exhibiting electronic conductivity having improved performance when used as electrode in, e.g. a fuel cell. Remaining particles of praseodymium oxide in the surface could also be advantageous.

### FIELD OF THE INVENTION

The present invention relates to a doped metal oxide structure for use in electrochemical devices and to a method of manufacturing said doped metal oxide structure.

### BACKGROUND OF THE INVENTION

The performance and long term stability of solid oxide fuel cells (SOFCs), solid oxide electrolysis cells (SOECs), oxygen membranes and electromotive force (EMF) devices may be influenced by the oxygen electrode used therein.

U.S. Pat. No. 6,017,647 relates to an oxygen electrode for a solid state electrochemical device comprising a porous structure having an interpenetrating network of an ionically conductive and an electronically conductive material. An electrocatalyst different from the electronically conductive material is dispersed within the pores of the porous structure by infiltration after the sintering step.

U.S. Pat. No. 6,319,626 relates to an yttria-stabilized zirconia (YSZ) cathode comprising a high performance electrocatalyst based on perovskites. The electrode is formed and sintered prior to impregnation.

WO 00/25898 discloses doping of cerium oxides for the production of oxygen and hydrogen. The oxides are obtained by precipitating the respective composition from a solution containing all desired cations, followed by sintering the dried aggregates.

WO 2007/027144 relates to a doped ceria ion conductor which enables higher ionic conductivity at lower temperatures.

However, the structures disclosed in the application mentioned above do not increase the performance, the long term stability, and the tolerance to high temperature treatment of the oxygen electrode.

Hence, an improved electrode and method for manufacturing said electrode would be advantageous, and in particular a more efficient and/or reliable electrode would be advantageous.

### OBJECT OF THE INVENTION

It is an object of the invention to provide an electrode with improved long term stability and a method of manufacturing said electrode.

It may be also seen as an object of the invention to provide a method of manufacturing an electrode and an electrode with improved heat treatment stability, i.e. high tolerance to heat treatments.

A further object of the present invention is to provide an alternative to the prior art.

In particular, it may be seen as an object of the present invention to provide a method of manufacturing an electrode and an electrode that solve the above mentioned problems of the prior art by elements infiltration into doped metal oxides.

### SUMMARY OF THE INVENTION

Thus, the above described object and several other objects are intended to be obtained in a first aspect of the invention by providing a method of manufacturing an electrode, the method comprising: a) infiltrating of at least one element into a doped metal oxide; b) heating said doped metal oxide infiltrated with the at least one element.

Thereby, in a first aspect of the invention, the method of manufacturing an electrode provides an electrode with improved long term stability and improved heat treatment stability, i.e. high tolerance to heat treatments.

In order to improve performance and long term stability, electrodes need to exhibit low polarization losses. This can be achieved if the electrode material shows, e.g. fast oxygen redox kinetics, high electronic and ionic conductivity, chemical compatibility with other components, and stable microstructure at the operating temperature.

A method to produce composite electrodes exhibiting low polarization losses compared to conventional routes is the so-called infiltration or impregnation route. This may be applied to structures usually consisting of an oxide ion conducting porous backbone that is infiltrated with an electronic or mixed ionic and electronic conducting (MIEC) electrocatalyst.

The nanoparticulate grains of the electrocatalyst, obtained through the infiltration route, generally have a high surface area and therefore enhance the available area for oxygen surface exchange. However, it has been found that during long term operation and/or exposure to high temperatures, i.e.>600° C., the formed nanoparticles exhibit significant grain growth and subsequent loss of percolation thus increasing both the ohmic and polarization resistance.

In search of solutions, the inventors devise the invention by introducing an infiltration step of at least one element into a doped metal oxide preceding the heating step and the electrocatalyst infiltration step, thereby providing an infiltrated doped metal oxide structure.

Importantly the infiltration step of at least one element into a doped metal oxide occurs before the heating step and before the infiltration of the electrocatalyst. The electrode comprises a metal oxide referred to also as the backbone, ionic conducting backbone or simply the backbone material. The backbone material preparation lies within the person skilled in the art.

In some further embodiments the at least one element is a lanthanide, preferably a lanthanide soluble into ceria.

The at least one element may be selected from the group of Pr, Nd, Er, Tb, or a combination thereof.

In some other embodiments the at least one element is a transition metal.

In some further embodiments the at least one element is selected from the group of Cr, Mn, Fe, Co, Ni, V, Ru or a combination thereof.

In some even further embodiments the at least one element is or is selected from the group of W, Nb, Ta, Mo or a combination thereof.

Thus, in some embodiments the at least one element is praseodymium (Pr).

In some embodiments the at least one element are two elements.

Those two elements may be praseodymium and terbium.

The doped metal oxide may have the following general formula: M₁₋ₓAₓO_{2-δ}, wherein A is an alkaline earth or a rare earth and M is cerium or zirconium and wherein x is in the range between 0 and 1 and wherein δ is in the range between 0 and 1. The value of δ is generally determined by the oxygen activity around the material.

In some other embodiments the doped metal oxide has the following general formula: Bi₂₋₂ₓA₂ₓO_{3-δ}, wherein A is an alkaline earth or a rare earth and wherein x is in the range between 0 and 1 and wherein δ is in the range between 0 and 1. In some further embodiment A is selected from the group of Mg, Ca and Sr. A may be also selected from the group of Sc, Y, Gd, La, Sm, Er, Dy.

The infiltration step may occur by contacting the backbone material with a solution. Contacting may be achieved by providing a solution containing ions of the element, to at least one surface of the backbone so that the backbone is in contact with the solution containing the ions of the element. In some embodiments, infiltration may be achieved by soaking the doped metal oxide in a solution containing the ions of the element. The solution may have different concentrations of elements salts, e.g. between 0.001M to 10 M.

The infiltration step allows for introduction and penetration of the salt containing the ions of the element into the doped metal oxide backbone.

In some further embodiments, the infiltration of the at least one element occurs from an aqueous solution.

In some other embodiments the aqueous solution comprises nitrates.

Thus, the electrode may comprise gadolinium doped cerium oxide (CGO) as a backbone material and may be infiltrated or impregnated with an element such as praseodymium ions from an aqueous solution of praseodymium salt, such as praseodymium nitrate, prior to the heating step.

In some embodiments, the heating is performed at a temperature, higher or equal to 500° C., thereby causing the formation of nanoparticulate precipitates at the surface of the backbone and subsequent full or partial sintering or reaction with the backbone structure.

The heating step is a thermal treatment process occurring in the presence of air or some other atmosphere like dry H₂ and may be also referred to as sintering step, calcination step or simply as calcination. The heating is performed at high temperature, such as higher or equal to 500° C., preferably between 500 and 1500° C., even more preferably between 900 and 1250° C.

The high temperature treatment allows the ions of the element to diffuse into the CGO backbone. The resulting backbone has a co-doped subsurface exhibiting electronic conductivity. The remaining particles of oxide of the element in the surface may also be advantageous and exhibit enhanced activity at the surface. Subsurface is defined herein as within 0.1 nm from the external surface of the backbone grain.

In some further embodiments the method according to first aspect of the invention further comprises: a1) pre-heating at temperature lower or equal to 500° C., preferably at 350° C.

This pre-heating, pre-sintering or pre-calcination step allows for further infiltrations before the heating, sintering or calcination step.

In some further embodiments the method further comprises repeating step a) and a1) before step b).

If multiple infiltrations are desired, the infiltrated backbone is pre-calcined at temperature lower or equal to 500° C., preferably at 350° C., before each infiltration. This pre-calcination step at low temperature, such as at 350° C., follows each infiltration step and is performed before the sintering step. As a last step, the infiltrated backbone is heated at high temperature, such as 1000° C. In some further embodiments the method further comprises: c) infiltrating an electrocatalyst.

After the sintering step, an electrocatalyst is impregnated or infiltrated into the electrode. The infiltration of the electrocatalyst lies within the person skilled in the art.

Examples of electrocatalyst that can be infiltrated or impregnated are electronically conducting oxides e.g. Sr-doped LaMnO₃ and MIEC electrocatalysts e.g. Sr-doped LaCoO₃ and Sr/Fe-doped LaCoO₃.

The above described object and several other objects are intended to be obtained in a second aspect of the invention by providing an electrode manufactured according to the method according to the first aspect of the invention.

The electrode may be an oxygen electrode.

In some other embodiments, the electrode is a fuel electrode.

In some embodiments, the electrode comprises grains of the doped metal oxide and the electrode has a structure characterized by a concentration gradient of the at least one element within the grains of the doped metal oxide. The content of the at least one element varies from the grain interior towards the surface in a manner characterized by a core-shell type structure, so that the at least one element is present at the edge of the grain but is substantially not present at the core of the grain. The structure of the electrode is thus realized by controlled interdiffusion of the at least one element from the surface of the grains of the doped metal oxide during heating, where the element has been introduced via infiltration.

Thus, a partial substitution with at least one element occurs to the doped metal oxide. The partial substitution is brought about in a process that involves an infiltration and a heat treatment. The heat treatment leads to a decomposition of the infiltrated compound and the at least one element diffuses into the doped metal oxide.

Concentration gradient or functional gradient is herein defined as a gradient of concentration, i.e. a change in concentration of the element as a function of distance within and through the grains of the doped metal oxide. The definition of the concentration gradient becomes more apparent from and elucidated with reference to the embodiments described in the description of the invention. Grains refer to the crystal grains of the doped metal oxide, e.g. crystal grains of CGO.

In some embodiments the grains are surrounded by a continuous layer, i.e. without interruption, of doped metal oxide that was previously infiltrated with the at least one element.

In some further embodiments the electrode further comprises particles of the at least one element and/or particles of an oxide of the at least one element onto the surface of the grains of the doped metal oxide.

For example, the electrode may have a structure characterized by the presence of a continuous layer of praseodymium doped gadolinia doped ceria (CGPO) surrounding gadolinia doped ceria (CGO) grains.

The electrode is characterized by the presence of a doped cerium oxide infiltrated by praseodymium ions, producing, following the sintering step, a thin layer, e.g. of a thickness between 0.1 and 200 nm, of praseodymium doped CGO (CGPO) onto grains of CGO.

Thus, the electrode may comprise gadolinia doped ceria (CGO) surrounded by a continuous layer of praseodymium doped gadolinia doped ceria (CGPO).

In some embodiments the electrode may further comprise praseodymium oxide particles onto the continuous layer of CGPO.

The presence of praseodymium oxide particles is further advantageous as it may enhance the performance of the electrode, e.g. the polarization resistance, Rₚ, may be between 30-80% lower than the Rₚ of an electrode with un-modified CGO at a T between 600° C. and 800° C.

In some embodiments the electrode may comprise praseodymium doped gadolinia doped ceria (CGPO) grains having a concentration gradient of praseodymium within said grains.

In general, the electrode obtained with the proposed new method possesses high performance, long term stability, and high tolerance to heat treatment. Due to the impregnation step prior to firing, electronic conductivity and catalytic activity specifically on the surface of the CGO backbone are enhanced, leading to lower electrode polarization resistance.

The electrode obtained with the above described method achieves the best results regarding the suppression of a degradation of electrochemical performance. By comparison, pre-mixing CGO and a Pr oxide via conventional routes to form the electrode comprising a Pr-doped CGO backbone shows lower performance and less advantageous results. Further, Pr-doped CGO (CGPO) has a very high thermal expansion coefficient causing difficulties in getting CGPO to adhere to other substrates that usually have a lower thermal expansion coefficient. Thermal expansion mismatch usually results in mechanical failures which increase Rₚ. Thus, conventional procedure leads to lower performance, i.e. higher Rₚ.

The first, second and other aspects and embodiments of the present invention may each be combined with any of the other aspects or embodiments. These and other aspects of the invention will be apparent from and elucidated with reference to the embodiments described hereinafter.

### BRIEF DESCRIPTION OF THE FIGURES

The method and the electrode according to the invention will now be described in more detail with regard to the accompanying figures. The figures show one way of implementing the present invention and is not to be construed as being limiting to other possible embodiments falling within the scope of the attached claim set.

FIG. 1a is a schematic drawing of the steps of the method according to one aspect of the invention.

FIG. 1b is a schematic cross section showing grains modified by the method according to one of the aspect of the invention.

FIG. 2 is a schematic cross section showing grains modified by the method according to some embodiments of the invention.

FIG. 3 is a plot showing the polarization resistance, Rₚ, at 600° C. in air as a function of Sr doped LaCoO₃ (LSC) firing temperature for the samples using various backbones.

FIG. 4 is a plot showing the serial resistance, Rₛ at 600° C. in air as a function of LSC firing temperature for the samples using various backbones.

FIG. 5 is a schematic drawing of a solid oxide cell employing an oxygen electrode according to one aspect of the invention.

FIG. 5a presents a Dark-field scanning transmission electron microscopy (STEM) image where the CGO grains according to some embodiments of the invention, with Pr and LSC impregnations are represented in the image as bright regions.

FIG. 5b shows X-ray Kα peak intensities for the elements La, Pr and Ce from a STEM-EDS (energy dispersive X-ray spectroscopy) line scan in the 10 points indicated in FIG. 5a. FIG. 6 is a flow-chart of a method according to the invention.

### DETAILED DESCRIPTION OF SOME EMBODIMENTS

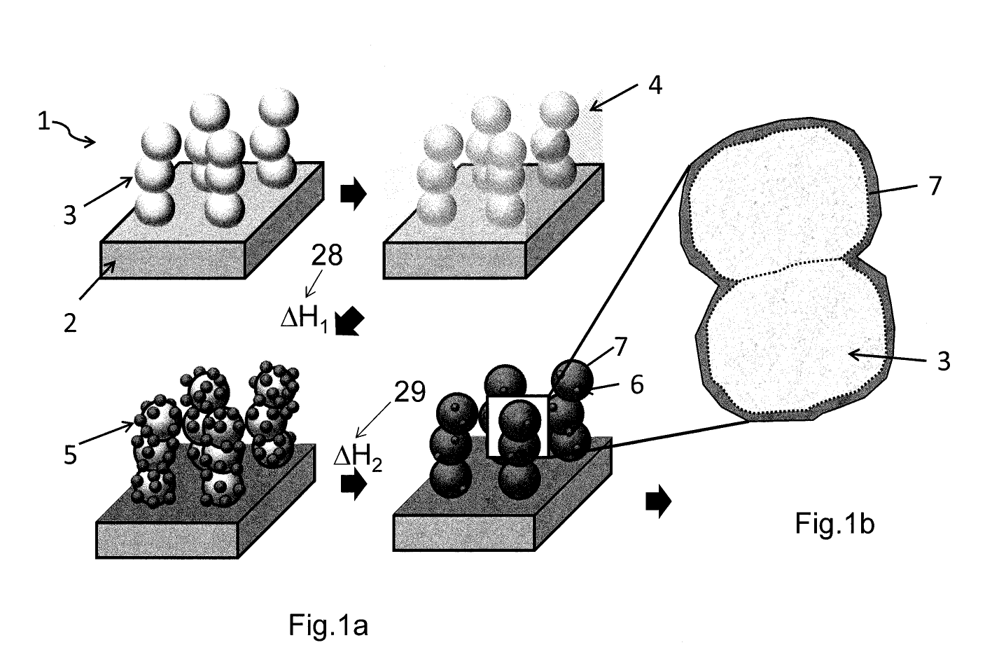

FIG. 1a is a schematic drawing of the steps of the method according to one aspect of the invention.

A part 1 of an electrochemical device is shown comprising an electrolyte, such as a solid electrolyte 2, and doped metal oxide grains, such as CGO grains 3.

The grains 3 supported by the electrolyte 2 are soaked in a solution, such as an aqueous solution 4 containing praseodymium salt. The precalcination step where heat 28 is applied leads to the formation of particles 5 containing praseodymium.

The last step is the sintering step where heat 29 is applied to the part 1 leading the praseodymium ions to diffuse into the CGO grain forming a continuous layer 7 of praseodymium doped gadolinia doped ceria surrounding gadolinia doped ceria grains 3.

In some embodiments, following the sintering step, praseodymium oxide particles 6 may be present onto the continuous layer 7.

FIG. 1b is a magnified schematic cross section of two grains 3 of CGO surrounded by a continuous layer 7 of CGPO.

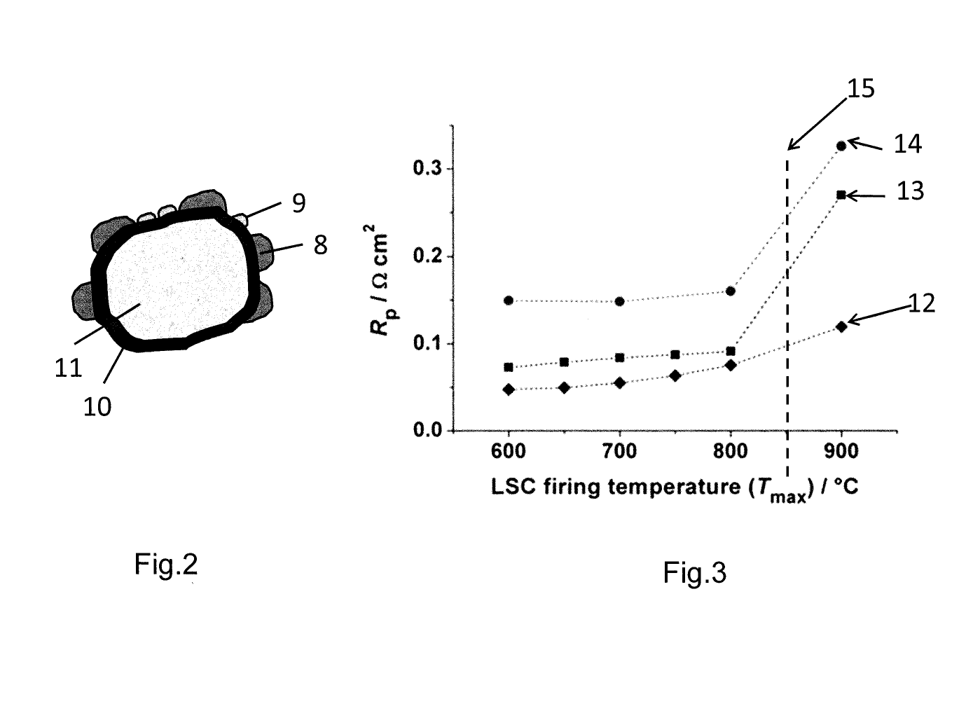

FIG. 2 is a schematic drawing showing the grains modified by the method according to some embodiments of the invention.

In FIG. 2 the grain 11 of CGO is surrounded by a continuous layer 10 of CGPO. Following the sintering step, an electrocatalyst 8 is further infiltrated or impregnated onto the doped grain 11, surrounded by the continuous layer 10 of co-doped metal, such as CGPO. The electrocatalyst 8 is thus deposited onto the continuous layer 10 as shown in FIG. 2.

The electrocatalyst 8 may be an electronic or mixed ionic and electronic conducting (MIEC) electrocatalyst such as Sr doped La CoO₃ (LSC) or Sr/Co doped La FeO₃ (LSCF).

In FIG. 2 the presence of metal oxide particle, such as Pr oxide nanoparticles 9 onto the continuous layer 10 is shown. The presence of the co-doped CGPO layer 10, as a sub-surface of the CGO grain 11 ensures continuous conducting paths. The presence of Pr oxide nanoparticles 9 onto the continuous layer 10 enhances the performance of the electrode as reducing the Rₚ of the electrode.

FIG. 3 is a data plot showing the polarization resistance (Rₚ) at 600° C. in air as a function of Sr doped LaCoO₃ (LSC) firing temperature for the samples using various backbones.

Points 14 connected by a dashed line represent Rₚ as a function of LSC firing temperature for electrodes comprising CGPO prepared by conventional routes, i.e. by solid state synthesis.

Points 13 connected by a dashed line represent Rₚ as a function of LSC firing temperature for electrodes comprising CGO with no further co-doping.

Points 12 connected by a dashed line represent Rₚ as a function of LSC firing temperature for electrodes according to some embodiments of the invention comprising CGO that has been infiltrated with Pr and has been fired at 1000° C.

It can be easily seen that the performance of the electrodes produced according to the method of the invention is improved with respect to an un-doped CGO, i.e. points 13, or CGPO produced via conventional routes, i.e. points 14. In particular it can be noticed that the Rₚ is 35% lower for the electrode according to the invention than the un-modified CGO at Tₘₐₓ=600° C.

Dashed line 15 represents a possible sealing temperature to which the cell will be exposed to when part of an SOFC or SOEC stack.

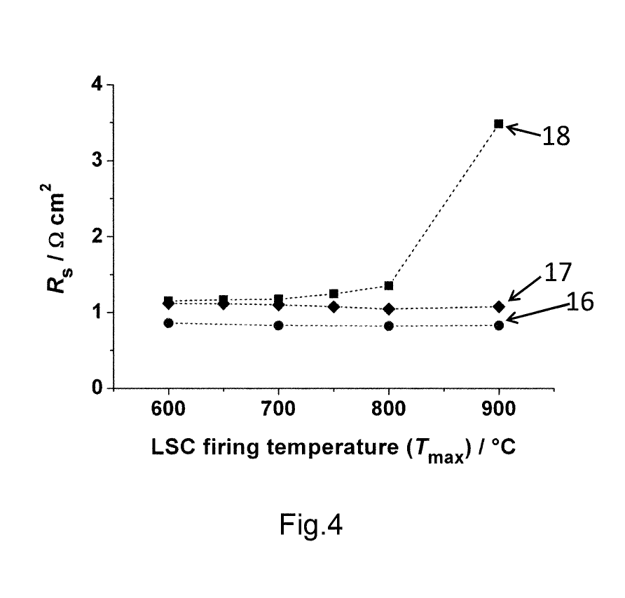

FIG. 4 is a data plot showing the serial resistance (Rₛ) at 600° C. in air as a function of Sr doped LaCoO₃ (LSC) firing temperature for the samples using various backbones.

Points 16 connected by a dashed line represent Rₛ as a function of LSC firing temperature for electrodes comprising CGPO prepared by conventional routes, i.e. by solid state synthesis.

Points 17 connected by a dashed line represent Rₛ as a function of LSC firing temperature for electrodes according to some embodiments of the invention comprising CGO that has been infiltrated with Pr and has been fired at 1000° C.

Points 18 connected by a dashed line represent Rₛ as a function of LSC firing temperature for electrodes comprising CGO with no further co-doping.

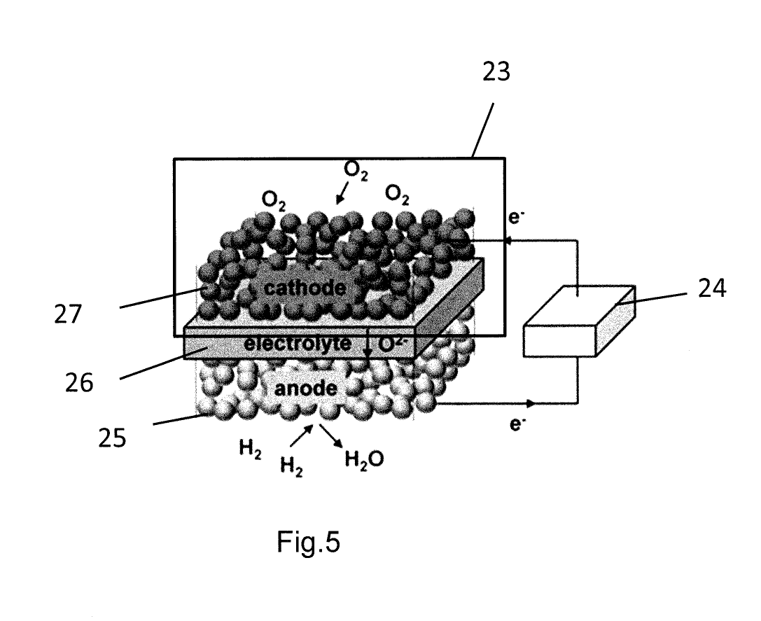

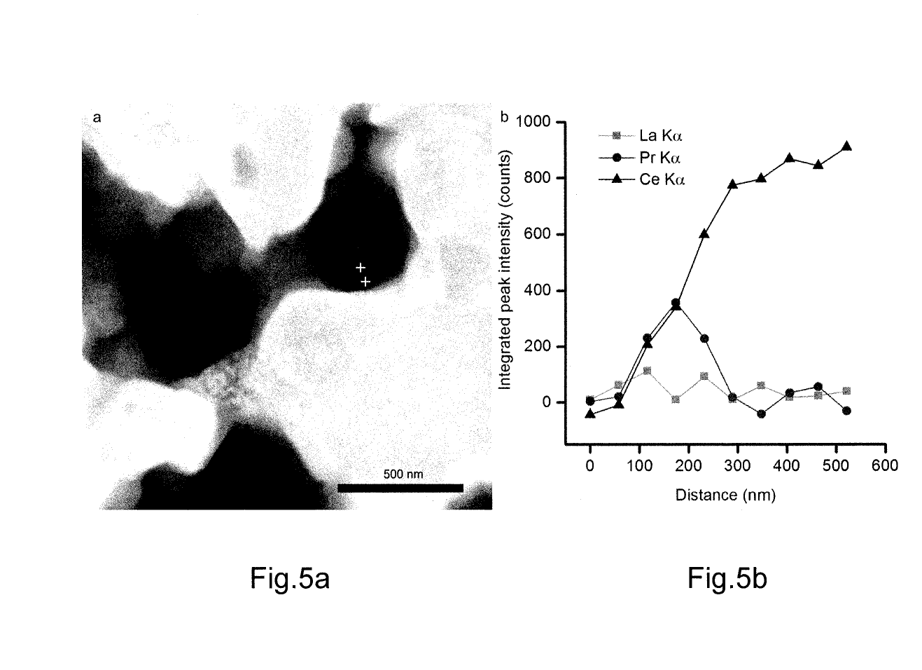

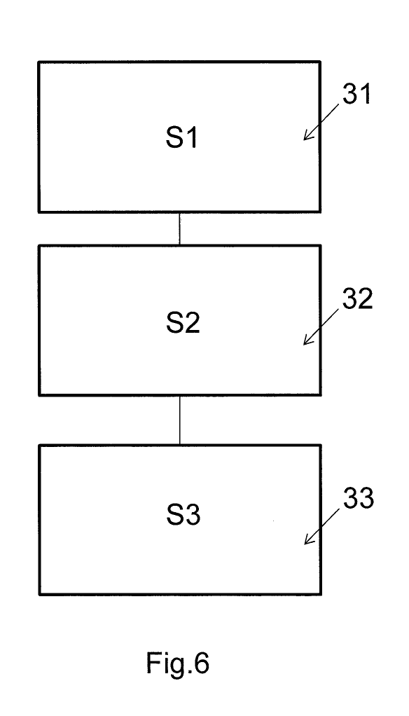

FIG. 5 is a schematic drawing of a solid oxide cell, such as a fuel cell, employing an oxygen electrode according to one aspect of the invention.

FIG. 5 shows an electrolyte 26 sandwiched in between a cathode 27 and an anode 25. As shown in FIG. 5, oxygen gas gets reduced at the cathode 27 and O²⁻ anions travel through the electrolyte 26. The O²⁻ anions react with hydrogen and produce water and electricity that can be collected through an external circuit 24.

The cathode or oxygen electrode 27 according to the invention has a high electronic conductivity, a high ionic conductivity, and a fast oxygen surface exchange characteristics and thus minimize internal losses, i.e. resistance and provide a stable electrode suitable for long term operation.

FIG. 6 is a flow-chart of a method according to some aspect of the invention. The method of manufacturing an electrode comprises: step 31 (S1), infiltrating of at least one element into a doped metal oxide; step 32 (S2) heating the doped metal oxide infiltrated with the at least one element; step 33 (S3) infiltrating an electrocatalyst in the doped metal oxide previously infiltrated with the at least one element.

In order to compare the performance of electrodes produced through the method of the invention and by conventional routes, such as solid state reactions, some samples were prepared, tested and reported below in example 1 and 2.

### EXAMPLE 1

Ce_{0.9}Gd_{0.09}Pr_{0.01}0_{2-δ} (CGPO-sss) was prepared via a conventional route, i.e. through a solid state reaction, by weighing precise amounts of CeO₂ (99.9%, Johnson Matthey Germany), Gd₂0₃ (99.9%, Alfa Aesar Germany), and Pr₆0₁₁ (99.9%, Alfa Aesar Germany) powders. The powders were mixed by ball milling with ethanol for 48 hours. The resulting mixture was dried and calcined at 1400° C. for 5 hours in air with heating and cooling rates of 2° C. min⁻¹. The resulting powder was ball milled in ethanol for 45 hours to break the agglomerates and obtain a more uniform particle size distribution. A screen printing ink of CGPO is prepared by adding the corresponding powder into a mixture of terpineol (Aldrich), dispersant (Solsperse 3000, Lubrizol), dibutyl phthalate (Merck), and ethyl cellulose (Fluka) in 50:9:2:1:0.075 weight ratio, respectively. The CGPO-sss backbone was prepared by screen printing the CGPO ink onto both sides of a 5×5 cm², dense 290 μm thick Ce_{0.9}Gd_{0.1}0_{1.95} (CGO) (KERAFOL) and sintering at 1150° C. for 2 hours in air.

In the infiltration route, an in-house CGO ink was screen printed onto both sides of a 5×5 cm², dense 180 or 290 μm thick CGO (KERAFOL). The samples were then fired at 1150° C. or 1250° C. for 2 h in air. To introduce Pr ions into the backbone, the infiltration method was employed. In this study, two concentrations of Pr precursor solutions were investigated, i.e. 0.013 M and 1 M.

During the process of Pr infiltration, Pr nitrate is introduced into a CGO backbone. If multiple infiltrations are desired, the infiltrated backbone is precalcined at 350° C. before each infiltration. As a last step, the backbone is fired at 1000° C.

All the backbones are further infiltrated six times with LSC and fired at varying firing temperatures (Tₘₐₓ). To investigate the performance with varying infiltrate firing temperature, the infiltrated cathodes were heated in-situ in an electrochemical setup at temperatures ranging from 300-900° C. A temperature program providing a desired temperature profile was used to ensure that an impedance spectrum from each measuring temperature is obtained as samples are heated and cooled progressively in the rig. Initially, the samples are heated to a maximum firing temperature, i.e. a Tₘₐₓ up to 900° C., and then they are cooled to 300° C. where an impedance measurement is performed. The samples are then heated further, carrying out impedance measurements at each step. Impedance spectra from each measuring temperature are compared from their corresponding Tₘₐₓ. In order to ensure sufficient current collection, Pt paste was painted onto both sides of the symmetric cells. It has previously been established that the Pt paste used for current collection showed inferior electrochemical performance compared to that of standard perovskite based SOFC cathodes. Electrochemical impedance spectroscopy (EIS) was carried out with a frequency range from 0.07 Hz to 100 kHz or with a frequency range from 0.06 Hz to 1 MHz under open circuit conditions and a 50 mV amplitude AC signal.

The EIS plane plots of symmetric cathodes composed of various backbones sintered at 1150° C. and infiltrated six times with LSC have been analysed. The trend at varying Tₘₐₓ shows increasing polarization resistance, Rₚ. The Rₚ values plotted against LSC firing temperatures are summarized in FIG. 3. When a CGPO-sss is used as a backbone, the same increase in Rₚ as an undoped CGO backbone was observed with increasing LSC firing temperature. It was also found that Rₚ values at Tₘₐₓ=600−900° C. were higher than those obtained from a CGO backbone. This discrepancy can be attributed to the difference in the microstructure of the two backbones which was confirmed by scanning electron microscopy (SEM) imaging. CGO backbones infiltrated one and three times with Pr (1 M concentration, fired at 1000° C.), before infiltrating the LSC electrocatalysts also show increasing Rₚ with increasing LSC firing temperature. However, compared to the infiltrated cathode without Pr and infiltrated cathode with CGPO-sss, the increase in Rₚ at Tₘₐₓ=900° C. was suppressed. Further, the overall Rₚ's at all temperatures are lower compared to the cathodes with other backbones. The lowest Rₚ values, which were obtained at Tₘₐₓ=600° C. are 0.048 and 0.039Ω cm² for the backbones infiltrated one and three times with Pr, respectively. It is noteworthy to mention that these values are within the range of lowest Rₚ's in a previous study, where the CGO backbone was fired at 1050° C. and LSC infiltration was 9 times. The lowest Rₚ obtained from these optimum conditions in the previous study was 0.044 cm². With regards to the effect of the amount of Pr, increasing the amount of Pr slightly decreases the overall Rₚ. No significant difference was observed in the relative trends in Rₚ with the amount of Pr.

In the case of Rₛ, as shown in FIG. 4, all the backbones containing Pr whether prepared by solid state reaction or infiltration shows slightly decreasing Rₛ with increasing LSC firing temperature up to Tₘₐₓ=800° C. A slight increase has been observed at Tₘₐₓ=900° C. For the infiltrated cathode with a CGO backbone, it has been observed that the Rₛ increases significantly at Tₘₐₓ=900° C.

### EXAMPLE 2

Another batch of samples was tested. This time employing a CGO backbone sintered at 1250° C. with and without Pr. Further, the concentration of Pr (0.0132 M) was significantly lower than the first case. The CGO backbone with Pr was also preheated at 1000° C. prior to LSC infiltration like in the first case. Both samples were infiltrated six times with LSC and fired at varying temperatures. The Rₚ in both samples increases with increasing LSC firing temperature. However, it seen from the sample with Pr that the increase in Rₚ, at Tₘₐₓ=900° C. was not as significant compared to the sample without Pr. This result was also seen in the abovementioned discussion. Regarding Rₛ the sample without Pr shows increasing Rₛ with increasing LSC firing temperature while the sample with Pr shows almost no change in Rₛ.

In general conventionally produced CGPO backbones infiltrated with LSC, e.g. as described in U.S. Pat. No. 5,670,270, results in electrodes having inferior performance when compared to the one produced according to the method of the invention. Differently from the conventional production of CGPO, the method of the invention introduces an infiltration step prior the sintering and the infiltration of the electrocatalyst, allowing for diffusion of an element, such as a lanthanide into the grains of doped metal oxides. Thus produces a structure as described in example 4.

### EXAMPLE 3

The method in the present invention can also be applied to fabricate a fuel electrode, e.g. an anode in a solid oxide fuel cell. A CGO backbone can be fabricated as described in Examples 1 and 2. This backbone can consequently be infiltrated with a 1 molar WO₃ precursor such as ammonium metatungstate. The infiltrated structure can be heated to 650° C. in air to decompose the precursor and form WO₃. A final heating at temperatures≧1000° C. can be performed to allow W to diffuse into the CGO grains. This modified backbone can then be infiltrated with an electrocatalyst such as a Ni-CGO mixture.

### EXAMPLE 4

A sample previously tested for electrochemical performance was prepared for transmission electron microscopy (TEM) by casting the sample in epoxy for stability and successively thinning to a thickness of ca. 100 nm with a focused ion beam (FIB) by using a Zeiss Crossbeam 1540xb. Transmission and dark field scanning transmission electron microscopy (STEM) was carried out by using a JEOL 3000F and equipped with a STEM unit and a high angle annular dark field (HAADF) detector. The microscope was operated at 300 kV and with a nominal probe size of 1 nm. For compositional analysis, energy dispersive spectroscopy (EDS) was carried out by using an Oxford Instruments EDS detector.

FIG. 5a presents a Dark-field STEM image where the CGO grains with Pr and LSC impregnations are represented in the image as bright regions. The dark regions in the image represent epoxy filling the sample pores. For the 10 points indicated in FIG. 5a the STEM probe rested for 1 min while recording an EDS spectrum, and the integrated background-subtracted X-ray Kα peak intensities for the elements La, Pr and Ce is presented in FIG. 5b. The peak intensities are presented as a function of distance from the first scanned point which starts from the dark region. The distance between each point is 58 nm. The nominal electron probe size is 1 nm, but broadens in the sample up to ca. 8 nm. The high energy Kα signals from these elements were used as indicators for LSC, Pr and CGO respectively, instead of the lower energy signals (the L- or M-line) for which many peaks overlap. According to FIG. 5b, Pr is present at the edge of the CGO grain while the concentration of Pr is ca. 0 at the center of the CGO grain. A relatively strong signal from both Pr and Ce is observed over a distance of ca. 150 nm, which indicates intermixing of Pr and CGO. Several additional scans confirmed the same trend i.e. overlapping Pr and Ce signals at the edge of the CGO grains while the Pr signal is close to 0 at the grain centers. Simulations via the software CASINO indicates that the electron beam is broadened up to a diameter of ca. 8 nm, which is small compared with the distance of 58 nm between each scan point. The overlap of Pr and Ce is therefore not likely an artifact due broadening of the ray of electrons in the sample.

FIG. 5b also presents a La signal at the CGO grain edge. In several scans a signal of La is observed at the CGO grain edges. Often the La signal is stronger closer to the pores than the Pr signal indicating that the LSC is situated at the CGO grain surfaces. For a few CGO grains, no Pr was observed at the edge.

Example 4 thus confirms the core-shell type structure CGPO-CGO produced as shown in FIG. 1b or 2 where Pr is intermixed with the CGO at the grain edges but is not present at the center of the grain. Thus, as shown by FIGS. 5a and 5b the grain of CGO that has been infiltrated with Pr according to the method of the invention shows a concentration gradient of Pr within the grain, and a grain surrounded by a continuous layer of CGPO.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of manufacturing an electrode, said method comprising:
a) infiltrating of at least one element into a doped metal oxide;
a1) pre-heating at a temperature lower than or equal to 500° C.;
b) heating said doped metal oxide infiltrated with said at least one element, wherein said heating is performed at a temperature higher than or equal to 500° C., thereby allowing ions of said at least one element to diffuse into said doped metal oxide and producing an electrode comprising grains of said doped metal oxide, wherein a concentration gradient of said at least one element within said grains is produced and, wherein said grains are surrounded by a continuous layer of doped metal oxide infiltrated with said at least one element;
c) infiltrating an electrocatalyst; and
repeating steps a) and a1) before step b).

2-24. (canceled)

25. The method according to claim 1 wherein said at least one element is a lanthanide, Pr, Nd, Er, or Tb, or a combination thereof.

26. The method according to claim 1, wherein said at least one element is a transition metal, Cr, Mn, Fe, Co, Ni, V, or Ru or a combination thereof.

27. The method according to claim 1, wherein said at least one element is W, Nb, Ta, or Mo or a combination thereof.

28. The method according to claim 1 wherein said doped metal oxide has the following general formula:
M₁₋ₓAₓO_{2-δ},
wherein:
A is an alkaline earth or a rare earth element,
M is cerium or zirconium,
x is in the range between >0 and 1, and
δ is in the range between 0 and 1.

29. The method according to claim 1, wherein said doped metal oxide has the following general formula:
Bi₂₋₂ₓA₂ₓO_{3-δ},
wherein:
A is an alkaline earth or a rare earth element,
x is in the range between >0 and 1, and
δ is in the range between 0 and 1.

30. The method according to claim 28, wherein A is selected from the group consisting of Mg, Ca and Sr.

31. The method according to claim 28, wherein A is selected from the group consisting of Sc, Y, Gd, La, Sm, Er, and Dy.

32. The method according claim 1 wherein said infiltration of said at least one element occurs from an aqueous solution.

33. The method according to claim 32, wherein said aqueous solution is a Praseodymium nitrate solution.

34. The method according to claim 1, wherein said at least one element are two elements.

35. The method according to claim 34, wherein said two elements are Pr and Tb.

36. An electrode manufactured according to the method according to claim 1, comprising grains of a doped metal oxide having at least one element infiltrated in said doped metal oxide, wherein said electrode has a concentration gradient of said at least one element within said grains.

37. The electrode according to claim 36, wherein said grains are surrounded by a continuous layer of doped metal oxide infiltrated with said at least one element.

38. The electrode according to claim 36, wherein said electrode comprises grains of said doped metal oxide and said electrode has a concentration gradient of said at least one element within said grains of said doped metal oxide.

39. The electrode according to claim 36, wherein said electrode comprises grains of said doped metal oxide and said electrode has a concentration gradient of said at least one element within said grains of said doped metal oxide and wherein said electrode has a continuous layer of doped metal oxide infiltrated with said at least one element surrounding said grains.

40. The electrode according to claim 36, further comprising particles of said at least one element and/or particles of an oxide of said at least one element onto the surface of said grains of said doped metal oxide.

41. The electrode according to claim 36, wherein said continuous layer is a continuous layer of praseodymium doped gadolinia doped ceria (CGPO) and, wherein said grains are gadolinia doped ceria (CGO) grains.

42. The electrode according to claim 36, further comprising particles of said at least one element and/or particles of an oxide of said at least one element onto the surface of said grains of said doped metal oxide and further comprising electrocatalyst particles on said continuous layer.

43. The electrode according to claim 36, wherein said continuous layer is a continuous layer of praseodymium doped gadolinia doped ceria (CGPO) and, wherein said grains are gadolinia doped ceria (CGO) grains and further comprising praseodymium oxide particles on said continuous layer.
